(19) United States
(12) Patent Application Publication
(10) Pub. No.: US 2026/0117139 A1
(43) Pub. Date: Apr. 30, 2026

(54) SILICONE OILS MATCHING REFRACTIVE INDEX OF TRANSPARENT MATERIAL/OPTICALLY CLEAR LIQUID WITH A KINEMATIC VISCOSITY IN A WELL-DEFINED RANGE

(71) Applicant: Preciflex SA, Neuchâtel (CH)

(72) Inventors: Axel FANGET, St. Sulpice (CH); Mathieu OULEVEY, Lausanne (CH); Jean-Luc BURDY, Territet (CH); Alain JACCARD, Sainte-Croix (CH); Toralf BORK, Enges (CH); Jean GUBELMANN, Yverdon-Les-Bains (CH); Johann ROHNER, Pomy (CH); Luc MAFFLI, Corminboeuf (CH); Sandro REGINELLI, La Neuveille (CH)

(73) Assignee: Preciflex SA, Neuchâtel (CH)

(21) Appl. No.: 18/562,368

(22) PCT Filed: May 20, 2022
(86) PCT No.: PCT/IB2022/054743

§ 371 Date: Nov. 20, 2023

Related U.S. Application Data
(60) Provisional application No. 63/190,845, filed on May 20, 2021.

(51) Int. Cl. C10M 107/50; C10M 105/76; C10N 30/20; C10N 40/06; G04G 99/00

(52) U.S. Cl. CPC C10M 107/50; C10M 105/76; C10M 2227/045; C10M 2229/0415; C10M 2229/0425; C10M 2229/0515; C10N 2030/20; C10N 2040/06; G04G 99/00

(57) ABSTRACT

A system and method/apparatus is provided which includes a fluid mix that when mixed together, creates a blend that matches a refractive index of a transparent material with which the fluid is in contact such as borofloat 33, borosilicate, float glass or fused silica, or transparent polymers, arid to have a kinematic viscosity in a certain range.

### CROSS REFERENCE TO RELATED APPLICATIONS

This application claims the benefit of U.S. Provisional Application No. 63/190,845, filed May 20, 2022, the content of the entirety of which is explicitly incorporated herein by reference and relied upon to define features for which protection may be sought hereby as it is believed that the entirety thereof contributes to solving the technical problem underlying the invention, some features that may be mentioned hereunder being of particular importance.

### IDENTIFICATION OF PARTIES CONCERNED

The Applicant of the present intellectual property matter is Preciflex SA of Switzerland. At the time of filing, John B. Moetteli and the firm Da Vinci Partners LLC of Switzerland represent the Applicant.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

The invention relates to the field of chemistry, in particular to silicone oil compositions, use of said compositions and a method for controlling/tuning/adjusting viscosity and refractive index of silicone oil compositions (polysiloxane). This invention relates to silicone oil compositions and blends of such silicone oil compositions. The herein proposed blends are intended to match a refractive index of a transparent (optically clear) material, such as borofloat 33, borosilicate, float glass or fused silica, and to have a kinematic viscosity in a certain range.

The invention concerns silicone oil components that can be mixed together to a blend that match a refractive index of a transparent material, such as precious stones with a compatible refractive index (RI 1.3 to 1.5), borofloat 33, borosilicate, float glass or fused silica, polymethyl methacrylate (PMMA), polycarbonate and other transparent polymers, and to have a kinematic viscosity in a certain range.

### SUMMARY OF THE INVENTION

A system and method/apparatus is provided which includes a fluid blend that matches a refractive index of a transparent material with which the fluid is in contact, such as, any precious stones, borofloat 33, borosilicate, float glass or fused silica, PMMA, polycarbonate and other transparent polymers, and to have a kinematic viscosity in a certain range, so as to define the mobility of the objects immersed in the liquid, and to allow the filling and degassing of the liquid.

An object of the invention is to provide silicone oil compositions that, when mixing at least two of such compositions to a blend, the properties of the blend match a refractive index of a transparent material, such as borofloat 33, borosilicate, float glass or fused silica, and to have a kinematic viscosity in a certain range. The blend is further adapted to be used in an animation and/or indication capsule or be of interest in building an electrowetting display,

### BRIEF DESCRIPTION OF THE DRAWINGS

The attached drawings represent, by way of example, different embodiments of the subject of the invention.

FIG. 1A is a viscosity (log)-refractive index (lin) chart.

FIG. 1B is an exemplary refractive index-wavelength chart referenced in the invention.

FIG. 2 is a cross-sectional side view of a device which uses the composition(s) of the invention.

FIG. 3 is a perspective, cross-sectional view of an indicator device which uses the composition(s) of the invention.

FIG. 4 is a perspective view of a device which uses the composition(s) of the invention.

FIG. 5 is a side, cross-sectional view of another device which uses the composition(s) of the invention.

FIG. 6 are progressive views of the assembly of an interchangeable indicia under a transparent display.

FIGS. 7A to 7B are schematic views of an embodiment of the invention, wherein a light source is installed on a mobile element held loosely in a structure, immersed in a fluid composition of the invention.

FIGS. 8A to 8D are cross-sectional, schematic views of an embodiment of the invention, wherein the embodiment includes a chain of rigid links attached via articulating joints, guided with pulleys, grooves or guides, immersed in the composition of the invention.

FIG. 9 is a perspective view of an embodiment of the invention, comprising a sealed capsule containing a liquid composition, wherein mobile elements are immersed in the liquid composition.

FIG. 10 is a perspective view of an embodiment comprising a sealed capsule containing a composition of the invention.

FIG. 11 is an exemplary density-refractive index chart/graph referenced in the invention.

FIG. 12 is a schematic view of another embodiment of the invention, providing a “suspended-in-air” effect,

FIG. 13 is a schematic view of an embodiment comprising a composition capable of damping the acceleration of a shock-sensitive device.

FIG. 14 is a schematic view of another embodiment comprising a shock-sensitive device suspended by a first flexible membrane filled with a composition of the invention.

FIG. 15 is a schematic view of a variant of the embodiment of FIG. 14.

FIGS. 16A to 16C is a schematic view of an embodiment including Light Emitting Diodes immersed in a liquid composition.

FIGS. 17A to 17D is a schematic view of an embodiment comprising a liquid filled capsule.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’, ‘top’ and ‘bottom’, and the like in the Description and/or in the claims are not necessarily used for describing exclusive relative position, Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as it is exemplary in nature, serving to describe the best mode of the invention known to the inventors as of the filing date hereof. Consequently, changes may be made in the arrangement and/or function of any of the elements described in the exemplary embodiments disclosed herein without departing from the spirit and scope of the invention.

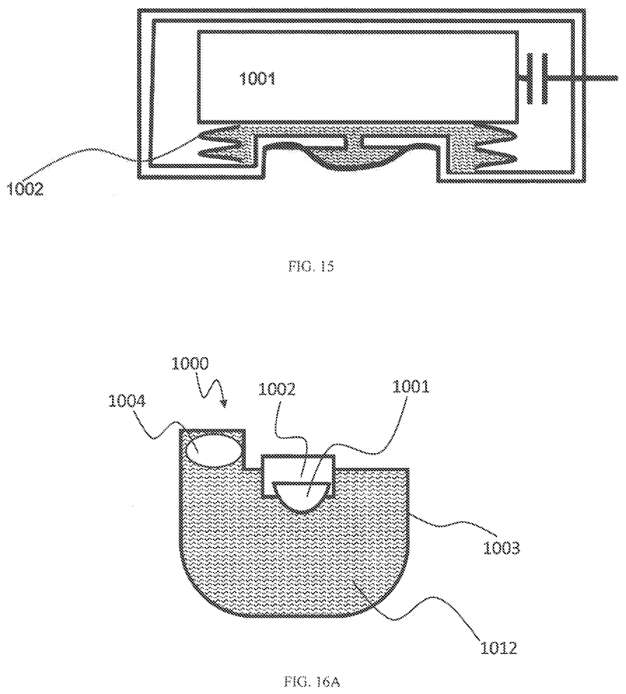

The present invention relates to silicone oil compositions. In a preferred embodiment, the silicone oil composition according to the present invention is a blend of at least two liquids. The blend is intended to match a refractive index of a transparent material, such as precious stones, borofloat 33, borosilicate, float glass or fused silica, polymethyl methacrylate (PMMA), polycarbonate and other transparent polymers, and to have a kinematic viscosity in a certain range, so as to define the mobility of the objects immersed in the liquid, and to allow the filling and degassing of the liquid. The blend is further suitable to be used within an encapsulation, typically of closed, rigid, stiff, inflexible nature, such as an animation and/or indication capsule as, for example, disclosed in international patent application Nos. PCT/IB2016/001448, on page 10, lines 9-19; PCT/IB2017/001146, on page 9, line 12 to page 11, line 25; PCT/IB2019/058379, on page 4, lines 18-20; PCT/IB2019/058381, on page 1, lines 26-30; PCT/IB2019/058385, on page 1, line 30 to page 2, line 7; PCT/IB2020/053025; PCT/IB2020/055313, on Page 3, line 27 to page 5, line 9; or be of interest in building an electrowetting display such as, for example, disclosed in international patent application No. PCT/IB2018/058549, in particular, FIG. 15 and related text, page 61, lines 6-9, page 45, lines 1-15, FIG. 70 and related text, which, although the refractive index matching is not mentioned, the capsule is mentioned to be at least partially transparent and in FIG. 15, the whole display can be transparent, so that the interchangeable indicia can be placed behind it. Consequently, at least one of the liquids must be transparent. In order for the electrowetting to function properly, the viscosity of the liquids is an important parameter, for example page 61, lines 6-9 mentions that the active liquid is a polar solvent, is non-miscible with a passive fluid, and has high surface tension. The passive fluid has low surface tension, is non-miscible with an active liquid, and has low viscosity. The passive fluid may be gaseous or liquid, and if it is used in the present invention as a liquid, it is preferably an apolar/nonpolar solvent. Also in this reference, but not related to electrowetting, page 45, lines 1-15, it states that therefore, the torque can be calculated in a certain manner, and that this is a truly remarkable result. The required torque in this situation depends only on the viscosity of the considered fluid, and on the desired return time, the tube length being given. For a liquid-vacuum interface, this torque would be divided by two, as is the average fluidic resistance of the tube during the return of the liquid in such a case. It is clear that the required torque depends directly on the viscosity of the liquid. The resulting required torque for water and silicone oil is presented in FIG. 70 of this reference. It is clear that, due to the difference in viscosity between water and silicone oil, the torque requirements are ultimately significantly different. However, in both cases, the torques are maintained within reasonable limits, The content of the entirety of the above-mentioned international patent applications is explicitly incorporated herein by reference and relied upon,

Silicone oil compositions of the present invention are typically mixtures of silicones, whose proportions are finely tuned to result in an optically clear liquid with well-defined viscosity and refractive index.

The term “silicone oil” means a liquid made of molecules with at least one silicon atom, and especially polymers of repeating Si—O groups with organic side groups.

The silicone constituents are chosen to be non-toxic to a human being and to yield after mixing a solution that shows limited chemical or physical change within the specified temperature range. The silicone oil composition according to the invention typically comprises:

At least one or more branched or unbranched polysiloxane polymers with the Si—O—Si backbone and a viscosity above 1 cSt and refractive index above 1.3 (e.g., fluoro-derivated polysiloxanes can have RI of 1.33, matching the RI of water, allowing the generation of matching R1 dual fluid systems based on water). preferably above 1.35. Such a polysiloxane can be:
A polydimethylsiloxane (PDMS) polymer of formula (CH₃)₃Si[Si(CH₃)₂O]ₙSi(CH₃)₃O with a viscosity between 1cSt and 1000cSt and refractive index between 1.3 and 1.6, preferably between 1.35 and 1.41.
An aromatic siloxane with a refractive index between 1.3 and 1.8, preferably between 1.41 and 1.6 and a viscosity between 1cSt and 1000 cSt, which can be one of the following:
   DiPhenylsiloxane-DiMethylsiloxane Copolymers of formula (CH₃)₃Si[Si(Ph)₂O]ₘ[Si(CH₃)₂O]ₙSi(CH₃)₃)
   PhenylMethylsiloxane-DiMethylsiloxane Copolymers of formula (CH₃)Si[Si(CH₃)(Ph)O]ₘ[Si(CH₃)₂O]ₙSi(CH₃)₃)₃O
   PhenylMethylsiloxane polymers of formula (CH₃)₃Si[Si(CH₃)(Ph)O]ₙSi(CH₃)₃O
A disiloxane or trisiloxane with formula —Si(CH₃)₂—O—Si(CH₃)₂—R and R—Si(CH₃)₂—O—Si(CH₃)R—Si(CH₃)R—Si(CH₃)—R with any viscosity and refractive index
An alkyl or aromatic alkyl silicone homopolymer or copolymer with any viscosity and refractive index
A polysiloxane with fluorocarbon side chains with any viscosity and refractive index

The silicone oil according to one of above compositions having following properties:

### Refractive Index:

Between 1.3 and 1.8, that index specified at a temperature of 25° C. and a wavelength of 589.3 nm.

### Viscosity:

Depending on the requirements to be usable in a certain application, silicone oils with the same refractive index must be formulated at different viscosities. Typically, the viscosity is tuned independently of the refractive index to achieve target values between 1 cSt and 200 cSt (from 1 to 200 10⁻⁶m²·s⁻¹), with a liquid density comprised between 700 and 1300 kg/m³.

### Temperature Specification:

The temperature specification range is typically from 10° C. to 40° C., preferably from 0° C. to 50° C., preferably from −20° C. to 70° C., where the liquid according to the composition of the present invention remains optically clear, does not undergo phase transition or phase separation within a specified range. The change in refractive index and viscosity with temperature is fully reversible.

### Toxicity:

The oils according to one of the compositions of the present invention are compliant with REACH regulations and do not contain more than 0.1 wt. % of substances of very high concern (SVHC). REACH is a regulation of the European Union, adopted to improve the protection of human health and the environment from the risks that can be posed by chemicals, while enhancing the competitiveness of the EU chemicals industry.

Ideally, the composition does not contain any SVHC or toxic compounds. If necessary, the oil constituents are purified to get rid of them. Examples of such compounds are: 2,6-cis-Diphenylhexamethylcyclotetrasiloxane, Octamethylcyclotetrasiloxane (D4), Decamethylcyclopentasiloxane (D5) and Dodecamethylcyclohexasiloxane (D6). The three latter are building blocks for larger chains (PDMS), and are widely used in cosmetics. The oils according to one of the compositions of the present invention can therefore be used for consumer goods applications.

### Stability:

The oils according to one of the compositions of the present invention take advantage of the inertness of silicone compounds. The silicone compositions typically show no significant change in chemical or physical properties even after exposure to UV (such as 100 h at 60 W/m², 290-400 nm) or prolonged exposure to high temperature (such as 70° C., 6 months).

### Material Compatibility:

The oils according to one of the compositions of the present invention take advantage of the inertness of silicone compounds and their compatibility with most metals and polymers for a wide range of applications.

### Vapor Pressure:

The compositions of the present invention may comprise only low-volatility compounds to provide compatibility with manufacturing methods that require low-pressure environments, such as degassing or vacuum liquid priming or others. In such a case, the silicone oils according to the present invention do not show a significant change in their chemical or physical properties after a prolonged exposure to low pressure.

### Water and Gas Solubility:

The compositions of the present invention are not miscible with water (maximum 200 ppm at 85% relative humidity) and have a low gas solubility so that the risk of bubble formation in a closed container within a predefined temperature range is limited.

### Thermal Expansion:

In order to be usable within closed, rigid, stiff, inflexible encapsulation, the oils according to one of the compositions of the present invention are engineered to have a maximum thermal expansion coefficient of 0.002° C.⁻¹.

Hereinafter the method used for refractive index and viscosity adjustment of the oils according to one of the compositions of the present invention is described. The refractive index and viscosity are adjusted to the desired values by blending at least two (2) base liquids. The refractive index of the resulting liquid composition is approximately given by the weighted average of the base liquids'refractive indices. The average is weighted based on the volume fraction of each base liquid. For each mixture, correction factors must be calculated empirically. The same method is used for the viscosity, but on a logarithmic scale (Arrhenius equation). The base liquids and blending ratios are chosen to achieve the desired properties of the compound liquid. This can be presented graphically on a viscosity (log)—refractive index (lin) chart. As there is no universal theory accurately predicting the viscosity and refractive index of a mixture, more than one blending iteration may be necessary to adjust the oil to its exact specifications, or an empirical determination of the blending parameters for a given mixture may be necessary.

The man skilled in the art is familiar with the methods used for refractive index and viscosity adjustment of the oils according to one of the compositions.

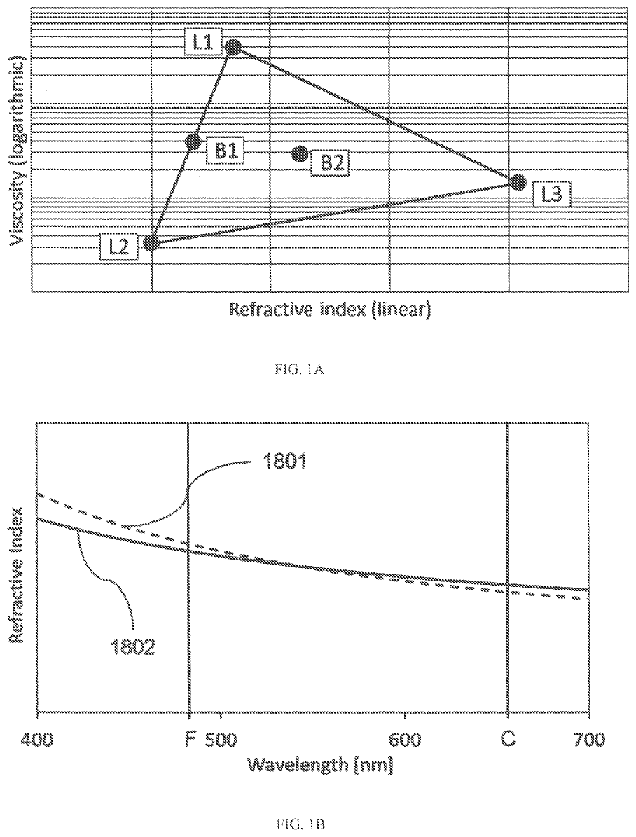

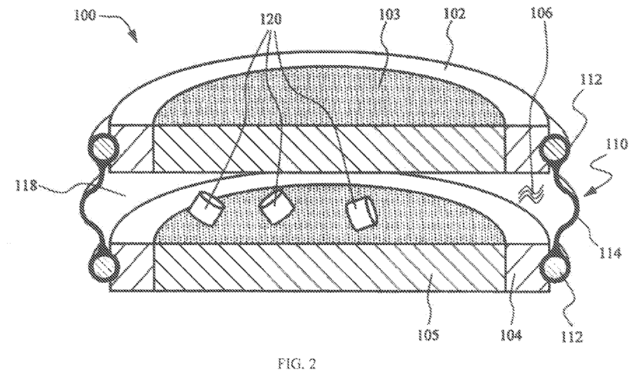

Referring now to FIG. 1A, a viscosity (log)—refractive index (lin) chart, wherein three (3) base liquids (L1, L2 and L3) are shown on the graph according to their respective viscosity and refractive index.

As a first approximation, a blend of L1 and L2, can only have properties on the line joining L1 and L2. For example, B1 is a blend containing 50 wt. % of L1 and 50 wt. % of L2. When blending the three (3) base liquids, the result can be anywhere inside the triangle delimited by L1, L2 and L3. For example, B2 contains 33½ wt. % of L1, 33⅓ wt. % of L2 and 33⅓ wt. % of L3. It is deduced that at least three (3) base liquids are required to independently adjust the refractive index and the viscosity. In reality, the properties of the blend differ significantly from such estimate.

Referring now to FIG. 1B, a refractive index-wavelength chart is shown. The refractive index of a transparent material is dependent on the wavelength of the light. The wavelength's dependency is called dispersion and can be defined as the difference in the refractive index between both ends of the visible spectrum. For example, the dispersion can be defined as D=n(F)−n(C), where F and C are Fraunhofer spectral absorption lines, F=486.134 nm, C=656.281 nm. The optimum matching of refractive indices between a liquid and an object to be hidden is achieved when the refractive index (1801) of the liquid/composition matches the refractive index 1802 of the object for all wavelengths of the visible spectrum. The silicone oil composition based on multiple components enables the adjustment of the refractive index not only at one given wavelength but also over a broader range of wavelengths by properly selecting the constituents of the formulation/composition. In addition, it is possible to minimize the effect of residual differences in dispersion by adjusting the refractive index at the specific wavelength for which the human eye sensitivity is the highest, typically around 550 nm, or at the wavelength for which the integral difference between both dispersion curves over the visible spectrum (400-700 nm) is minimum.

The method of the invention consists of using the above approximation as a first step, than making the first blend (blend #1), measuring the obtained properties, and adjusting the components proportions and/or adding one more liquid, until having obtained the desired set of properties.
Step 1: blend liquid according to approximation
Step 2: measure properties
Step 3: identify properties gap. If no gap, end of process.
Step 4: identify an additional liquid to be used, or a correction of the current proportions
Step 5: blend liquid according to the proportions defined in step 4, go to step 2.

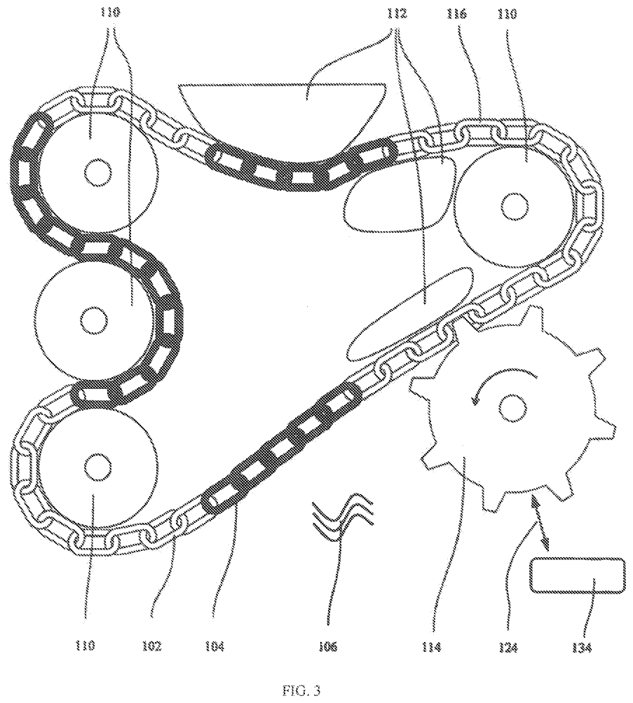

Referring now to FIG. 2, a fluid capsule 100 is shown. The fluidic capsule 100 consists of a top plate 102 attached to a bottom plate 104 by a semi-flexible wall 114, and contains at least one liquid 106. The liquid 106 may consist of three (3) base liquids (L1, L2 and L3) as described above. Even though the figure may show the top plate 102 having the same diameter as the bottom plate 104, the fluidic capsule 100 may also be constructed with the top plate 102 of a different diameter from the bottom plate 104. For example, the semi-flexible wall 114 may have a global conical shape instead of cylindrical. The liquid 106 is chosen to exhibit specific properties of viscosity, density, thermal expansion index, color, transparency, or light refraction index, etc. The capsule may also contain decorative elements 120 or structures (not shown) able to generate a visual animation actuated by gravity when the user/wearer changes the orientation of the fluidic capsule relative to a gravitational force, by an acceleration provided by the movement of the user/wearer, or by a manual or automatic actuation mechanism, such as described in U.S. Provisional Application 62/835,038 filed Apr. 17, 2019 or in PCT/IB2019/058381 filed Oct. 2, 2019, the contents of which are incorporated by reference herein, contained in the accessory, Item of jewelry, wristwatch, or any other fashion item where the fluidic capsule 100 is integrated. This feature of comprising. decorative elements 120 may not be expressly shown in any of the other embodiments disclosed in the instant description. This kind of encapsulation, typically of closed, rigid, stiff, inflexible nature, such as an animation and/or indication capsule as, for example, disclosed in international patent application No. PCT/IB2020/055313, the content of the entirety of this international patent application is explicitly incorporated herein by reference and relied upon.

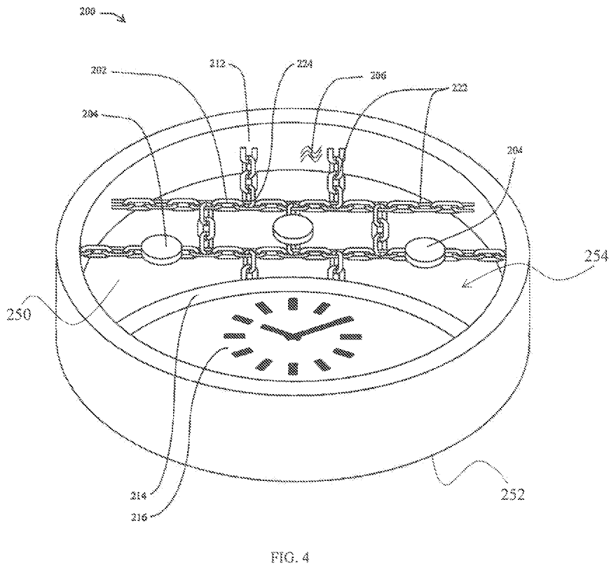

Referring now to FIG. 3, a system 100 is shown. At least a part of the system 100 is immersed in a liquid 106, such liquid having a refractive index substantially identical to the refraction index of selected parts 102, 110, 112, 114, 116 of the displacement mechanism that are intended to be rendered invisible or essentially invisible to an observer. The liquid 106 may consist of three (3) base liquids (L1, L2 and L3) as described above. The displacement mechanism may consist of a chain 116 of links 102 made of a material having a refractive index substantially identical to the refractive index of the surrounding liquid 106 so as to be essentially invisible to an observer. For a typical fluid such as glycerine or mineral oil, suitable materials for the parts 102, 110, 112, 114, 116 that are intended to be rendered invisible or essentially invisible to an observer are for example borosilicate, crystalline glass, fused silica, crown glass, flint glass, quartz, transparent ceramic (in particular Zerodur® or spinel), sapphire, polymethyl methacrylate (PMMA), polycarbonate, polyurethane. The chain 116 may include visible links 104 made of a material of refractive index significantly different from the refractive index of the surrounding liquid 106, such visible links may be made of precious metals or any other appropriate materials. Decorative elements may also be mounted on the invisible links 102 or on the visible links 104. The chain 116 of invisible links 102 and visible links 104 is mobilized via at least one gear wheel 114, and driven through a circuit defined by pulleys 110 and, optionally, guides 112. The pulleys 110, the guides 112 and/or the gear wheel 114 may be made of a material having a refractive index substantially identical to the refractive index of the surrounding liquid 106 so as to be at least substantially invisible to the user/wearer. The actuation mechanism (shown in schematic form as reference numeral 134) activates the at least one gear wheel 114 via a liquid-or watertight transmission (shown in schematic form as reference numeral 124). Such liquid-or watertight transmission 124 may be a magnetic transmission, a direct transmission with rubber seals, a substantially linear transmission encapsulated in a bellows, a hydraulic transmission or any appropriate transmission as known in the industry. The actuation mechanism 134 may be a direct action from the user, or a mechanism storing energy (mechanically, electrically, chemically, hydraulically, etc) and delivering movement at random so as to create a surprising effect, or upon triggering by the user, or a time-keeping mechanism providing a regular animation, optionally activated at specific points in time, like the top of the hour. In such case, an indication of time-related information may be provided. In case the system is implemented in a wearable item, the source of energy for the animation may be provided by a combination of a movement of the wearer and the effect of gravity on a pendulum or an oscillating mass rewinding the actuation mechanism 134. This kind of encapsulation, typically of closed, rigid, stiff, inflexible nature, such as an animation and/or indication capsule as, for example, disclosed in international patent application No. PCT/IB2019/058381, the content of the entirety of this international patent application is explicitly incorporated herein by reference and relied upon.

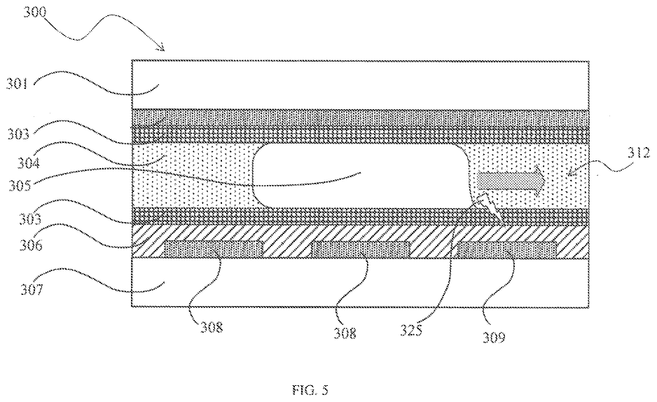

Referring now to FIG. 4, a decorative object 200 such as an animation and/or indication capsule comprising one or more transparent walls 212, 250, 252, an internal cavity 7 defined at least in part by the transparent wall or walls 212, 250, 252, a blend 206 as described above, the blend at least partially filling the internal cavity 254. The animation and/or indication capsule may be a watch embodiment or another kind of encapsulation, typically of closed, rigid, stiff, inflexible nature, such as an animation and/or indication capsule as, for example, disclosed in international patent application Nos. PCT/TB2016/001448, PCT/IB2017/001146, PCT/IB2019/058379, PCT/IB2019/058381, PCT/IB2019/058385, PCT/IB2020/053025, PCT/IB2020/055313, the content of the entirety of these international patent applications is explicitly incorporated herein by reference and relied upon.

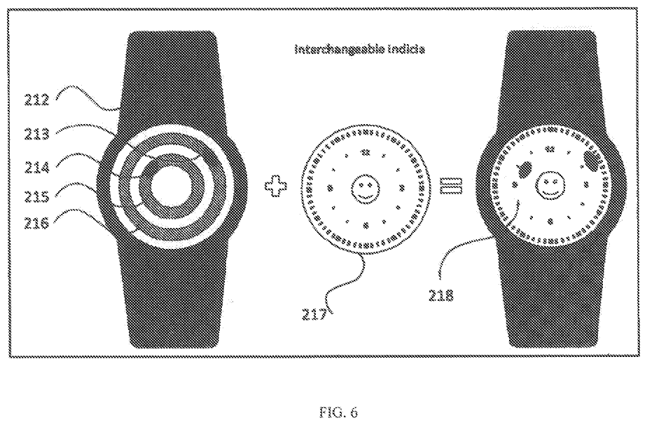

Referring now to FIG. 5, a decorative object 300 such as an electrowetting display comprising one or more transparent walls 301, 307, an internal cavity 312 defined at least in part by the transparent wall or walls 301, 307, a blend as described above, the blend 304 at least partially filling the internal cavity 312.

Electrowetting, as used throughout the present application, is understood to be the modification of the wetting properties of a surface (which is typically hydrophobic) by applying an electric field.

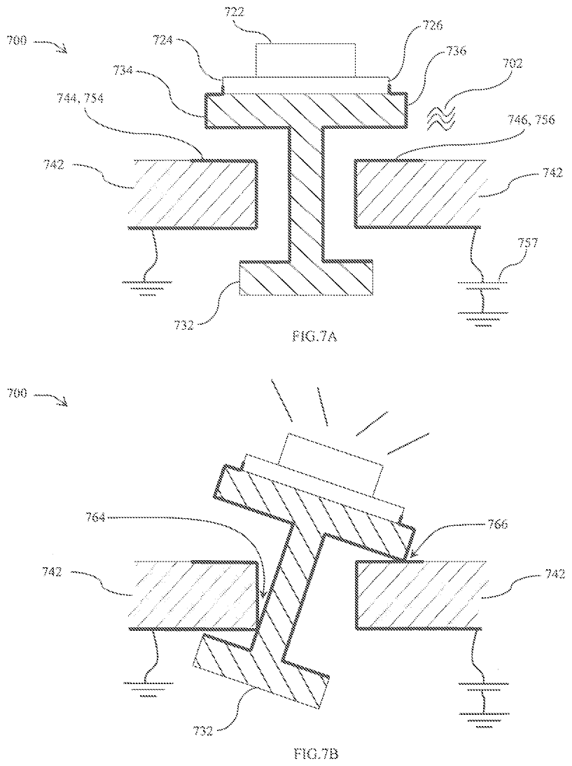

The electrowetting display (such as shown in FIG. 6) may be a watch embodiment or another kind of encapsulation, typically of closed, rigid, stiff, inflexible nature, such as an electrowetting display such as, for example, disclosed in international patent application No. PCT/IB2018/058549, the content of the entirety of these international patent applications is explicitly incorporated herein by reference and relied upon.

There are a number of additional examples of advantageous uses of the composition. In one embodiment, the composition of the invention is made sufficiently non-conductive that electrically conductive zones under differing electrical potential are in contact with the composition without significant current flowing through the composition. In other words, the composition has an insulation function. Therefore, when one or more such conductive zones touch each other, an electrical contact is created, allowing current to flow through this contact to activate an electrical function of the device, for example a light source in the device. The conductive zones are optionally made of transparent material, such as ITO or other organic or non-organic transparent conducting material, in solid material or in the form of printed or coated tracks or layers. The configuration of the conductive zones, their shape, their localization on a fix or on a mobile part, is advantageously selected to generate a randomly generated electrical contact, so as to activate the electrical function of the device in apparently random situations. In some embodiments, this has the effect of a flickering diamond in the sun. Because the refraction index of the composition is optionally be tuned to match with the refraction index of the conductive zones and/or with the refraction index of the fixed or mobile elements on which they are installed, all these elements may optionally be made invisible to the observer. As a result, an invisible electrical switch is provided. Hiding electrical circuitry is important as, generally speaking, such circuitry is out of place in luxury jewelry and watches.

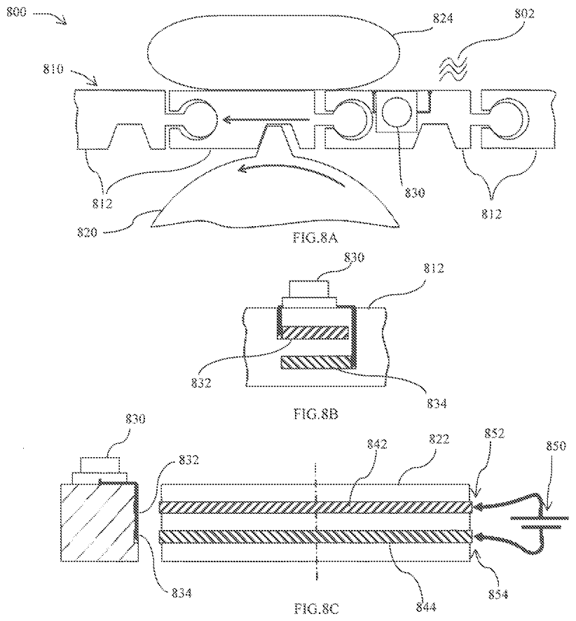

Referring now to FIGS. 7A to 7B, in one embodiment, a system 700 of the invention includes a light source 722 installed on a mobile element 732 held loosely in a structure 742, immersed in a fluid composition 702 of the invention, A part 744 of the structure 742 is covered with a conductive zone 754, connected to ground. Another part 746 of the structure 742 is covered with a conductive zone 756, connected to an electrical source 757. A first connection 724 of the light source 722 is connected to a conductive zone 734 that is installed on the mobile element 732, facing the conductive zone 754 of the structure 742. A second connection 726 of the light source 722 is connected to a conductive zone 736 that is installed on the mobile element 732, facing the other conductive zone 756 of the structure 742. The light source 722, the mobile element 732, the structure 742, the conductive zones 734, 736, 754, 756 may be made of transparent material and may match the refractive index of the composition 702 in order to be invisible to the observer.

Referring now to FIG. 7B, due to the large amount of play between the mobile element 732 in the structure 742, the mobile element 732 can randomly move to a position where the conductive zones are in contact 764, 766, in particular conductive zone 734 with conductive zone 754, and conductive zone 736 with conductive zone 756, respectively, in such case electrical current can flow through the contact points of the mobile element 732 and structure 742, activating the light source 722. The rate and manner of movement of the mobile element 732 is determined by the viscosity and density of the composition 702, by the mass and density of the mobile element 732, and by the acceleration and orientation given to the system 700 by the user/observer.

In another embodiment, the conductive zones are installed in such a way as to generate an electrical contact in known orientations, movements, accelerations and at predetermined times, so as to activate an electrical function of the device so as to provide an indication. As an example, such contact may be used in a time-indicating device to activate a light source at each predefined time interval (hour, minute, . . . ).

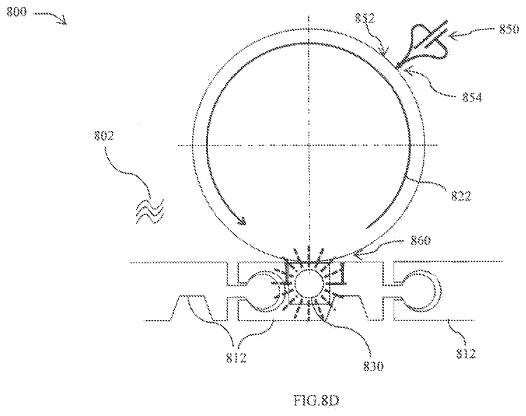

Referring now to FIG. 8A to FIG. 8D, a system 800 of the invention includes a chain 810 of rigid links 812 attached via articulating joints (in the figure, shown as ball joints), guided with pulleys 822, grooves or guides 824 to follow a predefined path, actuated by a mechanism 820 (symbolically represented as a part of a tooth wheel), immersed in the composition 802 of the invention. In one variant, the mechanism 820 is time-related, for example actuated or regulated by a watch movement, or by a voluntary action of the user/wearer, or actuated by a mechanical ballast mechanism driven by the movements of the wearer of the system, such as the mechanism of a self-winding watch, or the like, as well known in the industry. One or more links 812 of the chain 810 is equipped with a light source 830. A first connection of the light source is connected to a first conductive zone 832 on the chain link 812 and a second connection of the light source is connected to a second conductive zone 834 on the chain link 812. A pulley 822 has a first conductive zone 842 disposed so as to face the first conductive zone 832 of the link 812, and a second conductive zone 844 disposed so as to face the second conductive zone 834 of the chain link 812. An electrical source 850 is connected to the first conductive zone 842 and second conductive zone 844 of the pulley 822, for example via brushes, represented here symbolically with arrows 852, 854, respectively. The mechanism 820, light source 830, the chain links 812, the pulleys 822, the grooves or guides 824, the conductive zones 832, 834, 852, 854 may be made of transparent material and may match the refractive index of the composition 802 in order to be invisible to the observer. Some parts or sections of these elements may be hidden from the view of the user/wearer by decorations, or kept out of the field of view of the user/wearer.

Referring now to FIG. 8D, while the chain 810 is actuated, the chain link 812 eventually passes over/on the pulley 822, and the first conductive zone 842 of the pulley 822 comes into contact with the first conductive zone 832 of the chain link while the second conductive zone 844 of the pulley 822 comes into contact with the second conductive zone 834 of the chain link, generating electrical contacts 860, allowing electrical current to activate the light source 830 while the chain 810 is in this position.

The functionality of invisible electrical switch described here may be combined in many different ways so as to provide more complex switching patterns and/or for more than one electrically activated function. The invisible electrical switch described here may be used in any of the wearable devices described in international applications PCT/IB2019/058379, PCT/IB2020/053025, PCT/IB2019/058381, PCT/IB2019/058385, contents of the entirety of which is explicitly incorporated herein by reference and relied upon to define features for which protection may be sought hereby as it is believed that the entirety thereof contributes to solving the technical problem underlying the invention, some features that may be mentioned hereunder being of particular importance,

In a further embodiment, a solution to generate dynamic effect in a fluidic capsule is provided. Mobile elements move in a chamber filled with liquid, such as the composition of the invention. The mobile elements are made at least in part of a transparent material and include a visible part/element as well. The visible element facilitates the visualization of the movement of the mobile element and generates an animation, The transparent part serves as a structure to hold the visible elements and if necessary to orient the visible parts in a desired direction. Depending on its geometry the transparent part helps for guiding the displacement of the mobile element.

By matching the index of refraction of the liquid to the one of the transparent structuring element, one prevents the user from seeing the structuring transparent element. The displacement of the mobile elements which takes place due to gravity and the speed of the displacement is dependent of the viscosity of the liquid. By tuning both the refractive index and the viscosity of the liquid, one can generate the desired effect with the disappearance of the structure and a desired displacement speed.

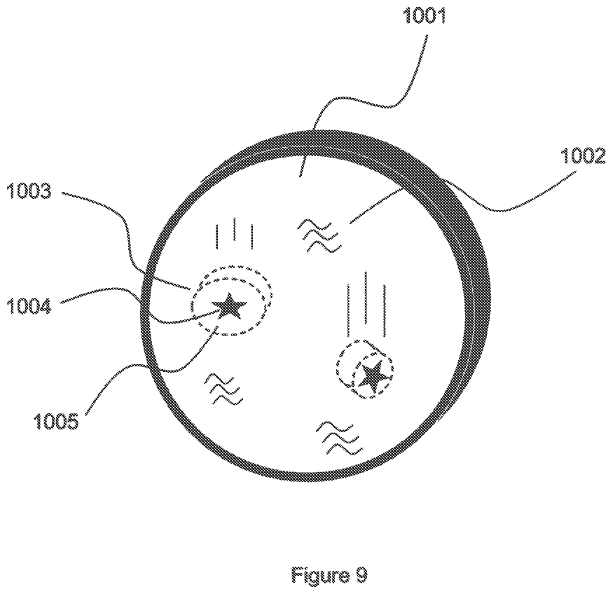

Now referring to FIG. 9, a sealed capsule 1001 contains a liquid composition 1002 and one or several mobile elements 1003. The structuring part 1005 of the mobile element 1003 is made of transparent material. The refractive index of the liquid 1002 is tuned to match the refractive index of the structuring element 1003. The mobile elements 1003 are activated in a manner determined by the direction of the gravity vector and the orientation of the capsule 1001. The viscosity of the liquid 1002 is tuned to adapt the displacement speed to the desired effect.

The present invention relies in part on the ability of independently tuning the refractive index or the viscosity without having a substantial impact on the other parameters.

In another embodiment, the mobile element has a connection to the fluidic capsule through an articulation made of one or several elements. These elements may also be invisible due to the proper matching of refractive index.

In another embodiment, the mobile element is actuated by a mechanism. The mechanism may be disposed inside or outside of the fluidic capsule. Due to its viscosity, the liquid around the mobile element will slow the movement of the element as compared to air. In order to have the desired visual effect, some parts or the totality of the moving element are made invisible by the proper matching of the refractive index of the liquid to the refractive index of the moving element. By tuning the viscosity of the liquid while keeping its refractive index unchanged, the resistance to movement of the mobile element, and therefore the speed of movement of the mobile element can be selected.

In some embodiments, the fluidic capsule contains both actuated and free mobile elements.

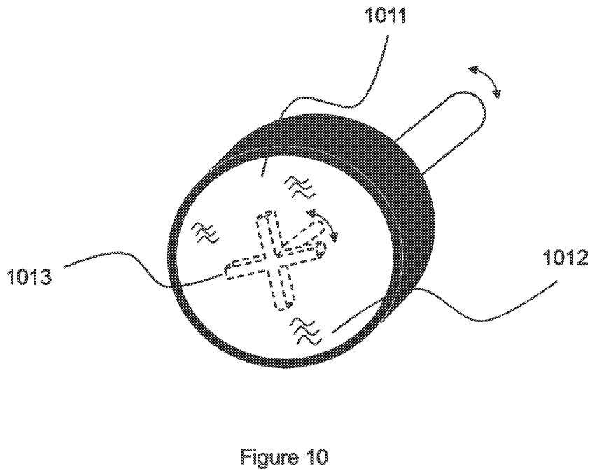

Now referring to FIG. 10, a sealed capsule 1011 contains a composition 1012 of the invention. An impeller 1013 is actuated by a rotating mechanism. In this configuration, the mechanism is outside the fluidic chamber. The friction between the impeller blades and the composition 1012 brakes rotational movement allowing a control of the speed. In this embodiment, the impeller 1013 is transparent and its refractive index matches the one of the composition 1012, making the displacement invisible to the user. The friction force is dependent of the viscosity of the composition 1012, which is why the control of viscosity without changing the refractive index is desired.

Silicone oil compositions of the present invention are typically mixtures of different silicone oil in proportions that are finely tuned to result in an optically clear liquid with well-defined viscosity and refractive index.

When the silicone oil composition is a mixture of three liquids, tuning the density of the mixture in order set the floating properties of an object inside the mixture.

In one embodiment, the mixture of the composition is adapted to a desired density while keeping the refractive index to a defined value.

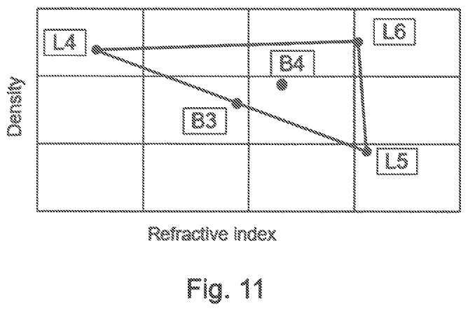

Referring now to FIG. 11, a density-refractive index chart/graph, wherein three base liquids (L4, L5 and L6) are shown according to their respective density and refractive index.

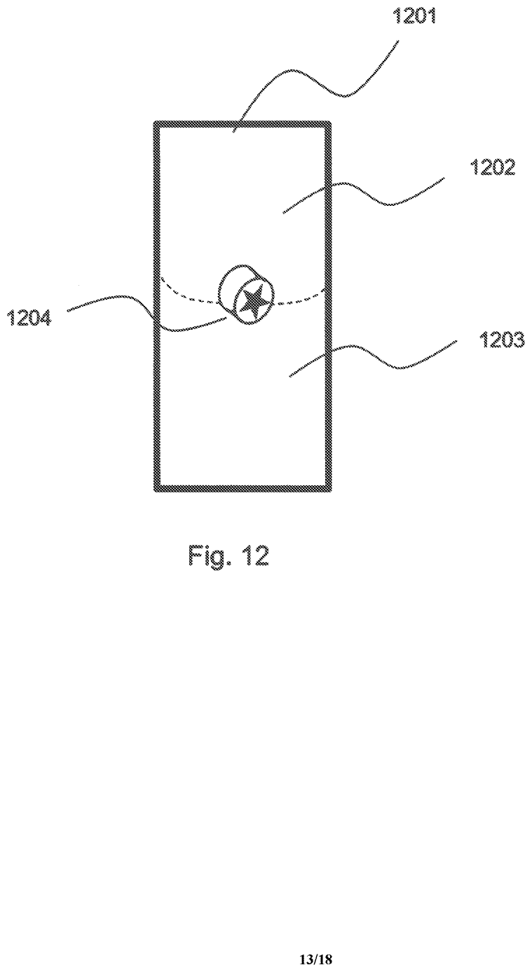

As a first approximation, a blend of L4 and L5, can only have properties on the line joining L4 and LS. For example, B3 is a blend containing 50 wt. % of L4 and 50 wt. % of L5. When blending the three base liquids, the result can be anywhere inside the triangle delimited by L4, L5 and L6. For example, B4 contains 33½ wt. % of L4, 33⅓ wt. % of L5 and 33⅓ wt. % of L6. It has been deduced, and so is assumed here, that at least three base liquids are required to independently adjust the refractive index and the density of the composition. In reality, the properties of the blend actually differ significantly from such estimate. Referring now to FIG. 12, in one embodiment, two non-miscible liquids 1202, 1203 are used in a fluidic chamber 1201 with a mobile element 1204, and at least one of the two liquids is a composition of the invention. By tuning or selecting the density of the one liquid 1202, 1203 lower than the density of the mobile element 1204 and by tuning or selecting the density of the other liquid 1202 or 1203 higher than the density of the mobile element 1204, one can make the mobile element 1204 float in a “suspended-in-air” effect at the interface 1205 (shown as a dashed line) between the two liquids. By simultaneously tuning or selecting the refractive index of both liquids 1202, 1203 to essentially be identical, the interface 1205 between the two liquids becomes invisible and the mobile element 1204 will create the effect of floating in the middle of the fluidic chamber 1201 even when the fluidic chamber is moved or returned.

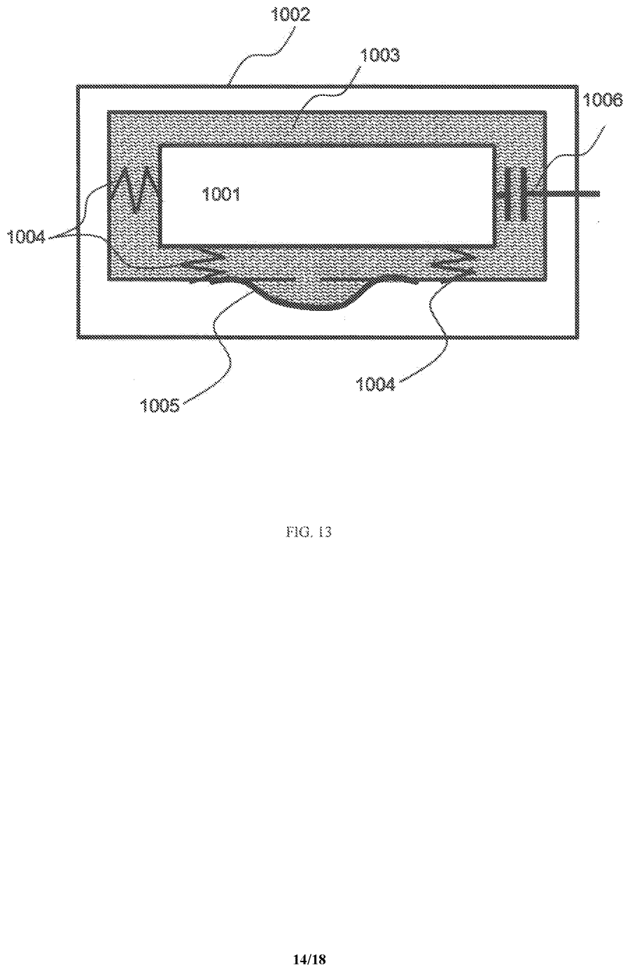

In a further embodiment, shown in FIG. 13, a composition which dampens the acceleration of a shock-sensitive device such as a watch movement or any shock-sensitive device is provided. The viscosity of the silicone oil used to dampen the shocks is tuned with the method described above in order to control the damping level of the system. Refractive index matching may be used to lower or suppress the optical refraction and reflection of light at the interfaces between the silicone oil mixture and transparent objects in contact with it. Those transparent objects might be chamber sidewalls, immersed objects or technical features such as fluidic resistances.

In its preferred embodiment, the shock-sensitive device 1001 is sealed in a hermetic capsule surrounded by a liquid 1003 with adjusted viscosity and refractive index. One, two, or several walls of the case 1002 can be transparent and the liquid 1003 can be optically matched with those transparent walls. The shock-sensitive device 1001 is suspended by one or several soft springs 1004 (with a low spring coefficient K) suspending the side or the bottom of the device to the case. These springs can be made softer than if the device 1001 was not immersed in a liquid thanks to Archimedes force present by immersing the device in the liquid. Those springs enable a motion if the device is submitted to acceleration. This motion is damped by the liquid 1003, a composition with tuned viscosity. The damping occurs by shear forces in the liquid around the moving device 1001. If required, a flexible element such as a corrugated membrane 1005 is optionally used to compensate for the thermal expansion of the liquid. If the shock-sensitive device is a watch movement, a clutch-like mechanism 1006 is used to set the time or other user functions, keeping the watch movement suspended by the springs only when the clutch is open.

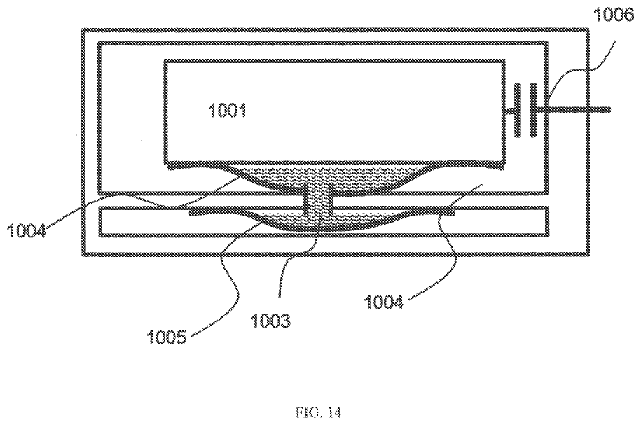

In another embodiment, shown in FIG. 14, the shock-sensitive device 1001 is suspended by a first flexible membrane 1004 filled with a liquid 1003, a composition of the invention. The liquid can flow through a channel into the volume enclosed within a second flexible membrane 1005 hidden elsewhere in the device. The viscosity of the silicone liquid can be tuned so that upon a shock, the liquid forced into the channel by the motion of the shock-sensitive device 1001 moves under the second flexible membrane 1005, hereby damping the motion of the device 1001 by shear forces in the liquid. The amount of damping can also be tuned by the dimension of the channel. If the shock-sensitive device is a watch movement, a clutch-like mechanism 1006 is optionally used to set the time or other user functions, keeping the watch movement suspended by the first membrane 1004 only when the clutch is open. Thermal expansion of the liquid is absorbed by the flexibility of the two membranes.

In still another embodiment, shown in FIG. 15, which is a variant of the previous one, the shock-sensitive device 1001 is suspended by a flexible bellows, and the flexible membrane can be embedded within this flexible bellow, preferably at its center.

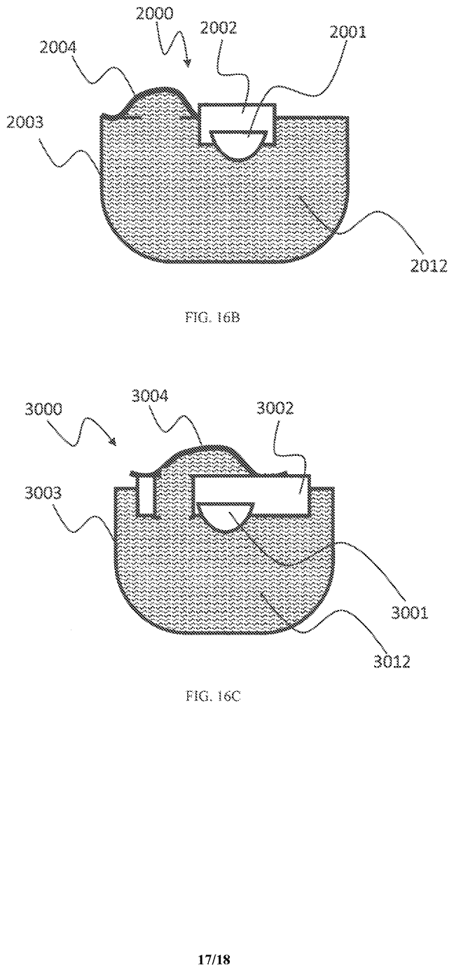

Yet another embodiment is shown in FIGS. 16A to 16C. Light Emitting Diodes (LEDs) are an energy-efficient technology to transform electrical current into electromagnetic radiation in the visible range by using a semiconductive P-N junction. However, the light emission efficiency of the P-N junction still depends on the temperature, so that power LED lighting (such as general consumer lamps and luminaires) need a thermal management system to dissipate the heat generated in the LED source. Referring now to FIG. 16A, a variant of the device of the invention uses a silicone oil mix/composition 1002 in a container 1003 whose sidewalls are transparent at least in areas through which light must be emitted. The package of a LED device 1001 is in direct contact with the silicone oil mix/composition 1002, or, as the silicone oil is electrically insulating, the LED die/device 1001 can alternatively be directly in contact with the silicone oil. The LED device 1001 is mounted on a support 1002 which provides electrical interconnects to the outside of the container 1003. The direct contact of LED package or LED die with the silicone oil provides efficient thermal cooling thanks to the good thermal contact between the LED and the silicone oil, by having a large silicone oil thermal mass, and by natural convection occurring in the silicone oil due to local heating in the direct vicinity of the LED. The container embeds a thermal compensating feature such as an air/gaseous bubble 1004 which should ideally be kept out of the light path by the geometry of the chamber. An alternative device 2000 is shown in FIG. 16B. In this embodiment, a flexible membrane 2004 is optionally be bonded to the chamber or in another alternative device 3000 as shown in FIG. 16C. A flexible membrane 3004 is bonded to the LED support 3002 to provide the required compliance and absorb the thermal expansion of the fluid without needing to have a bubble in the chamber. By adjustment of the refractive index of the silicone oil, the radiation pattern outside the LED is adjusted. By adjustment of the refractive index of the silicone oil to match the refractive index of the LED package and/or to the transparent walls of the container 1003, reflective light losses are reduced. By adjustment of the viscosity of the silicone oil, the natural convection dynamics is therefore tuned,

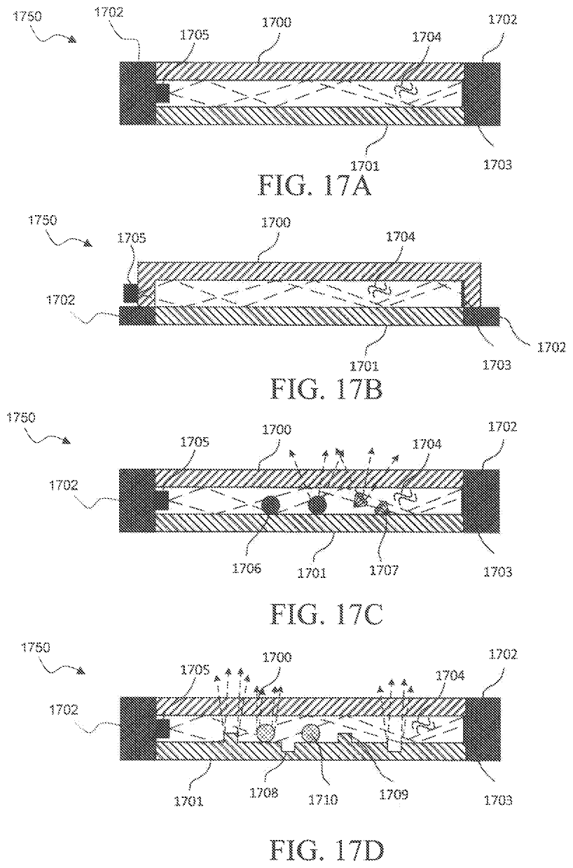

Referring, now to FIGS. 17A to 17D, in particular FIG. 17A, a liquid filled decorative capsule 1750 with a first transparent wall 1700 and an opposing, optionally transparent wall 1701 is shown. Both walls 1700, 1701 can be of the same or different transparent materials and are affixed to a capsule base 1702 in a leak-tight manner. This capsule is then filled with a liquid 1704 of a higher refractive index then the transparent wall(s). On the circumference of the capsule are attached one or more light sources 1705 and the remainder of the sidewall is optionally coated with a reflective layer 1703. The light source or sources 1705 is optionally attached inside the capsule immerged in the liquid 1704 as shown in FIG. 17A or could also be attached on the outside of the capsule as illustrated in FIG. 17B, where one of the transparent walls has a dome-shaped form. The light emitted by the light source(s) remains inside the decorative capsule due to total internal reflections (similar as in an optical light guide) at the interface between the liquid and the transparent walls as well as reflection from the reflective coating 1703. The refractive index of the liquid can be adjusted in order to maximize or minimize the amount of total internal reflection.

Referring now to FIG. 17C, a decorative capsule, based on the embodiment shown in FIG. 17A, is shown but could as well be based on the embodiment shown in FIG. 17B or such other embodiment, wherein solid elements 1706 or precious stones 1707 are encapsulated, that are free to move within the liquid. These solid elements scatter some of the light within the capsule towards an observer on the outside of the capsule, therefore making these objects more visible or rendering them shiny. The refractive index and/or viscosity of the liquid (also referred to as composition in other parts of the present description), once again, is adjusted/tuned to optimize/maximize the total internal reflections that would cause all solid elements to move inside the decorative capsule with a certain speed upon a change of orientation of the decorative capsule relative to gravity or an acceleration generated by a user when wearing or holding the decorative capsule.

Referring now to FIG. 17D, a decorative capsule based on one of the embodiments as shown in FIG. 17A or FIG. 17B or the like is shown, where one or both of the one or more transparent wall(s) is (are) structured to contain positive 1709 or negative 1708 relief features. This capsule optionally contains transparent objects 1710 in which, ideally, the transparent object as well as the structured transparent wall are of the same refractive index as the liquid 1704. Therefore, without light illumination, the relief features 1709 and/or 1708 as well the transparent objects 1710 are essentially invisible within the liquid. Due to the difference of the dispersion (see the description for FIG. 1A and IB) of the liquid 1704 compared to the dispersion of the transparent materials of wall 1700, 1701 or the transparent objects 1710, illuminating the inside of the capsule with white or specific wavelength light one can reveal the relief features and/or transparent objects'outlines as they will show up due to light refractions at the imperfectly matched refractive index wavelengths.

In a preferred embodiment, the invention provides a silicone oil composition which has the same or similar refractive index as a transparent barrier, a structure, a fix or mobile element which it is in contact, thereby making the barrier, the structure or the element invisible to the human eye.

In another advantage, the invention provides a silicone oil composition that is stable over a large temperature range.

In another preferred embodiment, the invention results in an optically clear liquid with well-defined viscosity and refractive index.

The invention may be summarized by any one of the below feature sets:
1. A silicone oil composition comprising at least two silicon oil constituents, preferably three, selected in relative quantities so as to match a refractive index of a transparent material, and at the same time to adjust the kinematic viscosity of the composition within a certain range, wherein the quantities are preferably weighted quantities.
2. The composition of feature set 1, wherein the transparent material is selected from one of the group of transparent materials consisting of precious stones, borofloat 33, borosilicate, float glass, fused silica, polymethyl methacrylate (PMMA), polycarbonate, cycloolefin copolymer, glass, crystalline glass, crown glass, flint glass, quartz, transparent ceramic (in particular Zerodur® or spinel), sapphire, and polyurethane.
3. The composition of any of the above feature sets, further adapted to be suitable for use within an encapsulation, typically a substantially closed, rigid, stiff, inflexible encapsulation, such as an animation and/or indication capsule.
4. The composition of any of the above feature sets, used in an electrowetting display.
5. The composition of any of the above feature sets, wherein proportions of the silicone oils constituents are tuned to result in an optically clear liquid with well-defined viscosity and refractive index.
6. The composition of one of feature sets 5, wherein the silicone constituents are chosen to be non-toxic to a human being and to yield after mixing a solution that shows limited chemical or physical change within the specified temperature range.
7. The composition of one of feature sets 5, or 6, wherein the silicone compositions typically comprise at least one or more branched or unbranched polysiloxane polymer with the Si—O—Si backbone and a viscosity above leSt and refractive index above 1.3.
8. The composition of feature set 7, wherein the polysiloxane of the polysiloxane polymer is selected from one of the group of polysiloxanes consisting of:
   a) a polydimethylsiloxane polymer of formula (CH₃)₃Si[Si(CH₃)₂O]ₙSi(CH₃)₃O with a viscosity between 1cSt and 1000cSt and refractive index 1.3 and 1.6;
   b) an aromatic siloxane selected from one of the group of aromatic siloxanes with a refractive index between 1.41 and 1.6 and a viscosity between 10 and 1000 cSt consisting of:
   b1) DiPhenylsiloxane-DiMethylsiloxane Copolymers of formula (CH₃)₃Si[Si(Ph)₂O]ₘ[Si(CH₃)₂O]ₙ Si(CH₃)₃O;
   b2) PhenylMethylsiloxane-DiMethylsiloxane Copolymers of formula (CH₃)₃Si[Si(CH₃)(Ph)O]ₘ[Si(CH₃)₂O]ₙ Si(CH₃)₃O;
   b3) PhenylMethylsiloxane polymers of formula (CH₃)₃Si[Si(CH₃)(Ph)O]ₙ Si(CH₃)₂O;
   b4) a disiloxane or trisiloxane with formula R—Si(CH₃)₂——O—Si(CH₃)₂—R and R—Si(CH₃)₂—O—Si(CH₂)R—Si(CH₃)R—Si(CH₃)—R;
   b5) an alkyl or aromatic alkyl silicone homopolymer or copolymer; and
   b6) a polysiloxane with fluorocarbon side chains.
9. The composition of the above feature set, wherein the refractive index of the composition is selected at a temperature of 25° C. and a wavelength of 589.3 nm.
10. The composition of feature set 9, wherein, depending on the requirements of a certain application, silicone oil constituents with the same refractive index are formulated at different viscosities, wherein typically, the viscosity is tuned independently of the refractive index to achieve target values between 1 cSt and 200 cSt, from 1 to 200 10⁻⁶ m²·s⁻¹ with a liquid density comprised between 700 and 1300 kg/m³.
11. The composition of any of the above feature sets, wherein the composition is selected to function within a temperature range from −20° C. to 70° C. preferably from 0° C. to 50° C. more preferably from 10° C. to 40° C., where the liquid according to the composition of the present invention remains optically clear in the said range, does not undergo phase transition or phase separation within the specified range, and wherein change in refractive index and viscosity with temperature is fully reversible.
12. The composition of any of the above feature sets, wherein the silicon oil constituents used in at least one of the compositions are compliant with REACH regulations and do not contain more than 0.1 wt. % of Substances of Very High Concern (SVHC), preferably the composition does not contain any SVHC substance or toxic compound and, if necessary, the oil constituents are purified to remove toxic compounds such as 2,6-cis-Diphenylhexamethylcyclotetrasiloxane, Octamethylcyclotetrasiloxane (D4), Decamethylcyclopentasiloxane (D5) or Dodecamethylcyclohexasiloxane (D6).
13. The composition of any of the above feature sets wherein such composition is formulated to show no significant change in chemical or physical properties after exposure to UV, in particular, after 100 h at 60 W/m², 290-400 nm or prolonged exposure to high temperatures such as 70° C., over a period of 6 months.
14. The composition of any of the above feature sets, wherein the oil constituents used are selected to have ideally a low-volatility in order to be compatible with low-pressure environments in order that the oil constituents do not show a significant change in their chemical or physical properties after a prolonged exposure to low pressure.
15. The composition of any of the above feature sets, wherein the composition is selected so as to not be miscible with water, such that the miscibility is limited to a maximum of 200 ppm at 85% relative humidity, and to have a low gas solubility so that the risk of bubble formation in a closed container is Limited.
16. The composition of any of the above feature sets, wherein the said compositions are formulated to have a maximum thermal expansion coefficient of 0.002° C.⁻¹.
17. The composition of any one of the above feature sets, wherein a decorative element is suspended therein, loosely captured between two adjacent structural elements.
18. The composition of any one of the above feature sets, wherein the decorative element comprises an LED connected to circuits disposed to contact the structural elements thereby making an electrical connection that lights the LED when the decorative element moves to a contact position.
19. The composition of any one of the above feature sets, wherein at least one decorative element is suspended therein, having a neutral buoyancy within the composition and therefore tends to float therein.
20. The composition of any one of the above feature sets, wherein at least one decorative element is suspended in a capsule filled with the composition, and wherein further, an agitator impellor made of a materials whose refractive index is matched to the composition is configured to agitate the composition, thereby causing movement of the at least one decorative element in the capsule.
21. The composition of any one of the above feature sets, wherein the decorative element has a first density and is suspended in a capsule comprising the composition at the interface between two liquids, at least one of the two liquids being a formulation of the composition, one of which has a density greater than the first density, and the other of which has a density less than the first density.
22. A decorative object (120, 200, 1003) embodied in an animation and/or indication capsule (100, 200, 1001, 1011) includes one or more transparent walls (102, 104, 114, 212, 250, 252) and an internal cavity (118, 254) defined at least in part by a transparent wall or walls (102, 104, 114, 212, 250, 252), wherein the internal cavity (118, 254) is at least partially filled with a composition as defined in any one of the above feature sets.
23. The decorative object (120, 200, 1003) of feature set 22 which comprises an encapsulation, typically a closed, substantially rigid, stiff, preferably essentially inflexible encapsulation, such as an animation and/or indication capsule.
24. The decorative object (120, 200, 1003) of feature set 22, and optionally the capsule (100, 200, 1001, 1011), embodied in an item of jewelry, wristwatch, clock, or any other fashion item.
25. A decorative object (300) including an electrowetting display comprising one or more transparent walls (301, 307), an internal cavity (312) defined at least in part by the transparent wall or walls (301, 307). and a composition according to one of the feature sets 1 to 21, the composition (304) at least partially filling the internal cavity (312).
26. The decorative object (300) of feature set 25, comprised of an encapsulation, typically a closed, substantially rigid, stiff, preferably inflexible encapsulation, such as an animation and/or indication capsule.
27. The decorative object (300) of feature set 25, wherein the object is an item of jewelry, wristwatch, clock, or any other fashion item.
28. Use of the compositions of any one of the feature sets 1 to 21 in the manufacture of decorative objects such as an item of jewelry, wristwatch, clock, or any other fashion item.
29. A method of adjusting refractive index and viscosity of a composition of oil constituents comprising at least two base liquids including the followings steps;
   (a) determining the refractive index of the resulting liquid composition by the weighted average of the base liquids'refractive indices and weighting the average based on the volume fraction of each base liquid; and
   (b) determining the viscosity of the resulting liquid composition by the weighted average on a logarithmic scale optionally using an Arrhenius equation, wherein the base liquids and composition ratios are chosen to achieve the desired properties of the compound liquid.
30. A decorative object enclosed within a chamber filled at least in part with a silicone oil constituent comprising one or more branched or unbranched polysiloxane polymers having a Si—O—Si backbone with a viscosity above 1 cSt and refractive index above 1.33.
31. The decorative object of any one of feature sets 22 to 27, wherein the object is an accessory such as an item of jewelry, wristwatch, clock, or any other fashion item where the fluidic capsule (100) is Integrated.
32. A method of mixing the composition of any one of feature sets 1 to 21, comprising following steps:
   a) determining target properties (viscosity and refractive index);
   b) blending a composition out of two silicon oil constituents of dedicated proportion according to an approximation;
   c) measuring the physical properties (viscosity and refractive index) of the blended composition of Step 2;
   d) determining the deviation between the target properties as determined in Step 1 and the physical properties as measured in Step 3—if no deviation, end of process—if there is a deviation, continue with the below step;
   e) identifying a third silicon oil constituent and an estimated proportion to the two silicon oil constituents used in Step b), or determine a correction of the proportion of the two silicon oil constituents used in Step b); and
   f) blending composition according to the proportions defined in Step e), go to Step c).
33. A system (700) including a light source (722) installed on a mobile element (732) held loosely in a structure (742), immersed in a composition as defined in of any of the feature sets 1 to 22.
34. A system (800) including a chain (810) of rigid links (812) attached via articulating joints, guided with pulleys (822), grooves or guides (824) to follow a predefined path, actuated by a mechanism (820), immersed in a composition as defined in of any of the feature sets 1 to 22.
35. A dampening system using the composition of one of feature sets 1 to 21, adapted to dampen the acceleration of a shock-sensitive device such as a watch movement or any shock-sensitive device, wherein a fluid composition (1003) is used to dampen the shock, the composition of which is tuned in order to control the damping level of the system and wherein reflection of light at the interfaces between the silicone oil constituent mixture and transparent objects in contact with the transparent objects are matched to lower or suppress the optical refraction, thereby enabling a motion if the device is submitted to acceleration dampened by the fluid composition (1003) with tuned viscosity.
36. The system of the above feature set, wherein the transparent objects include one of the group of transparent objects consisting of chamber sidewalls and immersed objects.
37. The system of one of feature sets 35 or 36, wherein the shock-sensitive device (1001) is sealed in a hermetic capsule surrounded by the fluid composition (1003) having further a selected viscosity and refractive index.
38. The system of one of feature sets 35 to 37, wherein at least one wall of a case (1002) is transparent and the liquid composition (1003) is optically matched with those of the transparent walls,
39. The system of one of feature sets 35 to 38, wherein the shock-sensitive device (1001) is suspended by one or several soft (i.e., having a low spring coefficient K) springs (1004) which are softer than required if no liquid suspension composition was used, through which springs the device is suspended to a side and/or a bottom of the case (1002).
40. The system of one of feature sets 35 to 39, wherein a flexible element such as a corrugated membrane (1005) is used to compensate for the thermal expansion of the liquid.
41. The system of one of feature sets 35 to 40, wherein the shock-sensitive device is a watch movement, wherein the system includes a clutch-like mechanism (1006) adapted to allow the setting of time or other user functions, the clutch-like mechanism keeping the watch movement suspended only by the springs when the clutch is open.
42. The system of one of feature sets 35 to 41, including first and second fluid composition filled, flexible membranes (1004, 1005) connected by a channel, wherein the shock-sensitive device is suspended by the first membrane (1004) filled with the fluid composition (1003), such that the fluid is able to flow through the channel and into a volume enclosed within the second flexible membrane (1005) disposed elsewhere in the device.
43. The system of one of feature sets 41 or 42, wherein the viscosity of the fluid composition (1003) is selected so that upon a shock, the fluid composition is forced into the channel by the motion of the shock-sensitive device (1001) moves under the second flexible membrane (1005), hereby damping the motion of the device (1001) by shear forces in the liquid.
44. The system of one of feature sets 42 or 43, wherein an amount of damping of the system is tuned by the dimension of the channel,
45. The system of one of feature sets 42 to 44, wherein the system includes a watch movement and a clutch-like mechanism (1006) adapted to set the time or other user functions, keeping the watch movement suspended only by the first membrane (1004) when the clutch is open.
46. The system of one of feature sets 42 to 45, wherein anticipated thermal expansion of the fluid composition is absorbed by the flexibility of the two membranes.
47. The system of one of feature sets 39 to 46, wherein the spring is a flexible bellows, wherein the flexible membrane is optionally embedded within this flexible bellows, preferably at its center.
48. The system of any one of feature sets 33 to 47, wherein a decorative element is suspended in a chamber disposed therein, loosely captured between two adjacent structural elements, the chamber being filled with a liquid.
49. The system of any one of feature sets 33 to 48, wherein the decorative element is an electrical light source connected to circuits disposed to contact the structural elements thereby making an electrical connection that activates the electrical light source when the decorative element moves to a contact position, wherein, optionally, the electrical light source and/or the electricity conducting elements are made invisible through a proper selection of refractive indices.
50. The system of one of feature sets 33-49, wherein at least one decorative element is suspended therein, having a neutral buoyancy within the composition and therefore tends to float therein.
51. The system of one of feature sets 33-50, wherein at least one decorative element is suspended in a capsule filled with the composition, and wherein further, an agitator impellor made of a materials whose refractive index is matched to the composition is configured to agitate the composition, thereby causing movement of the at least one decorative element in the capsule.
52. The system of one of feature sets 33-51, wherein the decorative element has a first density and is suspended in a capsule comprising the composition at the interface between two liquids, at least one of the two liquids being a formulation of the composition, one of which has a density significantly greater than the first density, and the other of which has a density significantly less than the first density.
53. The system of one of feature sets 33-52, wherein the viscosity of the oil constituents is tuned to adjust displacement speed of the enclosed objects.
54. A decorative capsule having at least an internal or external light source and one transparent barrier containing a composition according to any of the feature sets 1 to 21, wherein the refractive index of the composition is superior to the refractive index of the at least one transparent barrier so that the light produced by the light source remains confined within the decorative capsule.
55. The decorative capsule of feature set 54 including decorative elements immerged in the composition, wherein the decorative elements scatter some of the light produced by the light source within the capsule towards an observer on the outside of the capsule, therefore making these objects more visible or rendering them shiny.
56. A decorative capsule having at least an internal or external light source and one transparent barrier containing a composition according to any of the feature sets 1 to 21, wherein one of the one or more transparent barriers is structured to contain positive or negative relief features and wherein the refraction index of the composition is matched to the refraction index of the transparent barrier, wherein the positive or negative relief features scatter some of the light produced by the light source within the capsule towards an observer on the outside of the capsule, therefore making the positive or negative relief features more visible or rendering them shiny.
57. The decorative capsule according to feature set 56 including decorative elements immerged in the composition, wherein the decorative elements scatter some of the light produced by the light source within the capsule towards an observer on the outside of the capsule, therefore making these objects more visible or rendering them shiny,

It should be appreciated that the particular implementations shown and herein described are representative of the invention and its best mode and are not intended to limit the scope of the present invention in any way.

It should be appreciated that many applications of the present invention may be formulated.

As will be appreciated by skilled artisans, the present invention may be embodied as a system, a device, or a method.

The present invention is described herein with reference to block diagrams, devices, components, and modules, according to various aspects of the invention. It will be understood that each functional block of the blocks diagrams, and combinations of functional blocks in the block diagrams.

Accordingly, the block diagram illustrations support combinations of means for performing the specified functions, combinations of steps for performing the specified functions, and program instruction means for performing the specified functions.

Moreover, the system contemplates the use, sale and/or distribution of any goods, services or information having similar functionality described herein.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements such as those described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Additional features and functionality of the invention are described in the claims appended hereto and/or in the abstract. Such claims and/or abstract are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being Illustrative only, the spirit and scope of the invention being limited only by the claims which ultimately issue in this application.

1. A chamber and a silicone oil composition in combination, the silicone oil composition of the combination comprising at least two, preferably three, silicon oil constituents disposable in the chamber, the silicon oil constituents selected in relative quantities so as to match a refractive index of a transparent material, wherein the transparent material is selected from one of the group of transparent materials consisting of precious stones, borofloat 33, borosilicate, float glass, fused silica, polymethyl methacrylate (PMMA), polycarbonate, cycloolefin copolymer, glass, crystalline glass, crown glass, flint glass, quartz, transparent ceramic (in particular Zerodur® or spinel), sapphire, and polyurethane, and at the same time to adjust the kinematic viscosity of the composition within a certain range, wherein the quantities are preferably weighted quantities, the silicon oil composition further adapted to be suitable for use within the chamber, typically a substantially closed, rigid, stiff, inflexible chamber, optionally used in an electrowetting display,

2. The combination of claim 1, wherein proportions of the silicone oils constituents are tuned to result in an optically clear liquid with well-defined viscosity and refractive index.

3. The composition of one of claims 2, wherein the silicone constituents are chosen to be non-toxic to a human being and to yield after mixing a solution that shows limited chemical or physical change within the specified temperature range.

4. The combination of claim 2 or 3, wherein the silicone compositions typically comprise at least one or more branched or unbranched polysiloxane polymer with the Si—O—Si backbone and a viscosity above 1 and refractive index above 1.3.

5. The combination of claim 4, wherein the polysiloxane of the polysiloxane polymer is selected from one of the group of polysiloxanes consisting of:
a) a polydimethylsiloxane polymer of formula (CH₃)₃Si[Si(CH₃)₂O]ₙSi(CH₃)₃O with a viscosity between 1 and 1000 cSt and refractive index 1.3 and 1.6;
b) an aromatic siloxane selected from one of the group of aromatic siloxanes with a refractive index between 1.41 and 1.6 and a viscosity between 10 and 1000 cSt consisting of:
b1) DiPhenylsiloxane-DiMethylsiloxane Copolymers of formula (CH₃)₃Si[(Si(Ph)₂O]ₘ[Si(CH₃)₂O]ₙ Si(CH₃)₃O; (CH₃)₃Si[SiCH₃)(Ph)O]ₘ[Si(CH₃)₂)]ₙ Si(CH₂)₃O;
b2) PhenylMethylsiloxane-DiMethylsiloxane Copolymers of formula (CH₃)₃Si[Si(CH₃)(Ph)O]ₘ[Si(CH₃)₂O]ₙ Si(CH₃)₃)₃O;
b3) PhenylMethylsiloxane polymers of formula (CH₃)₃Si[Si(CH₃)(Ph)O]ₙSi(CH₃)O;
b4) a disiloxane or trisiloxane with formula R—Si(CH₃)₂—O—Si(CH₃)₂—R and R—Si(CH₃)₂—O—Si(CH₃(R—Si(CH₃)R—Si(CH₃)—R;
b5) an alkyl or aromatic alkyl silicone homopolymer or copolymer; and
b6) a polysiloxane with fluorocarbon side chains.

6. The combination of the above claim, wherein the refractive index of the composition is selected at a temperature of 25° C. and a wavelength of 589.3 nm.

7. The combination of claim 6, wherein, depending on the requirements of a certain application, silicone oil constituents with the same refractive index are formulated at different viscosities, wherein typically, the viscosity is tuned independently of the refractive index to achieve target values between 1 cSt and 200 cSt, from 1 to 200 10⁻⁶m²°S⁻¹ with a liquid density comprised between 700 and 1300 kg/m³.

8. The combination of any of the above claims, wherein the composition is selected to function within a temperature range from −20° C. to 70° C. preferably from 0° C. to 50° C. more preferably from 10° C. to 40° C., where the liquid according to the composition of the present invention remains optically clear in the said range, does not undergo phase transition or phase separation within the specified range, and wherein change in refractive index and viscosity with temperature is fully reversible.

9. The combination of any of the above claims, wherein the silicon oil constituents used in at least one of the compositions are compliant with REACH regulations and do not contain more than 0.1 wt. % of Substances of Very High Concern (SVHC), preferably the composition does not contain any SVHC substance or toxic compound and, if necessary, the oil constituents are purified to remove toxic compounds such as 2,6-cis-Diphenylhexamethylcyclotetrasiloxane, Octamethylcyclotetrasiloxane (D4), Decamethylcyclopentasiloxane (D5) or Dodecamethylcyclohexasiloxane (D6).

10. The combination of any of the above claims wherein such composition is formulated to show no significant change in chemical or physical properties after exposure to UV, in particular, after 100 h at 60 W/m², 290-400 nm or prolonged exposure to high temperatures such as 70° C., over a period of 6 months.

11. The combination of any of the above claims, wherein the oil constituents used are selected to have ideally a low-volatility in order to be compatible with low-pressure environments in order that the oil constituents do not show a significant change in their chemical or physical properties after a prolonged exposure to low pressure,

12. The combination of any of the above claims, wherein the composition is selected so as to not be miscible with water, such that the miscibility is limited to a maximum of 200 ppm at 85% relative humidity, and to have a low gas solubility so that the risk of bubble formation in a closed container is limited.

13. The composition of any of the above claims, wherein the said compositions are formulated to have a maximum thermal expansion coefficient of 0.002° C.⁻¹.

14. The combination of any one of the above claims, wherein a decorative element is suspended therein, loosely captured between two adjacent structural elements,

15. The combination of any one of the above claims, wherein the decorative element comprises an LED connected to circuits disposed to contact the structural elements thereby making an electrical connection that lights the LED when the decorative element moves to a contact position.

16. The combination of any one of the above claims, wherein at least one decorative element is suspended therein, having a neutral buoyancy within the composition and therefore tends to float therein.

17. The combination of any one of the above claims, wherein at least one decorative element is suspended in a capsule filled with the composition, and wherein further, an agitator impellor made of a materials whose refractive index is matched to the composition is configured to agitate the composition, thereby causing movement of the at least one decorative element in the capsule.

18. The combination of any one of the above claims, wherein the decorative element has a first density and is suspended in a capsule comprising the composition at the interface between two liquids, at least one of the two liquids being a formulation of the composition, one of which has a density greater than the first density, and the other of which has a density less than the first density.

19. A decorative object (120, 200, 1003) embodied in an animation and/or indication capsule (100, 200, 1001, 1011) includes one or more transparent walls (102, 104, 114, 212, 250, 252) and an internal cavity (118, 254) defined at least in part by a transparent wall or walls (102, 104, 114, 212, 250, 252), wherein the internal cavity (118, 254) is at least partially filled with a silicone oil composition comprising at least two, preferably three, silicon oil constituents selected in relative quantities so as to match a refractive index of a transparent material, and at the same time to adjust the kinematic viscosity of the composition within a certain range, wherein the quantities are preferably weighted quantities.

20. The decorative object (120, 200, 1003) of claim 19 which comprises an encapsulation, typically a closed, substantially rigid, stiff, preferably essentially inflexible encapsulation, such as an animation and/or indication capsule.

21. The decorative object (120, 200, 1003) of claim 19, and optionally the capsule (100, 200, 1001, 1011), embodied in an item of jewelry, wristwatch, clock, or any other fashion item.

22. A decorative object (300) including an electrowetting display comprising one or more transparent walls (301, 307), an internal cavity (312) defined at least in part by the transparent wall or walls (301, 307), and a silicon oil composition comprising at least two, preferably three, silicon oil constituents selected in relative quantities so as to match a refractive index of a transparent material, and at the same time to adjust the kinematic viscosity of the composition within a certain range, wherein the quantities are preferably weighted quantities, the silicone oil composition (304) at least partially filling the internal cavity (312).

23. The decorative object (300) of claim 21, comprised of an encapsulation, typically a closed, substantially rigid, stiff, preferably inflexible encapsulation, such as an animation and/or indication capsule.

24. The decorative object (300) of claim 22, wherein the object is an item of jewelry, wristwatch, clock, or any other fashion item.

25. Use of a silicon oil composition comprising at least two, preferably three, silicon oil constituents selected in relative quantities so as to match a refractive index of a transparent material, and at the same time to adjust the kinematic viscosity of the composition within a certain range, wherein the quantities are preferably weighted quantities in the manufacture of decorative objects such as an item of jewelry, wristwatch, clock, or any other fashion item.

26. A method of adjusting refractive index and viscosity of a composition of oil constituents comprising at least two base liquids including the followings steps:
(a) determining the refractive index of the resulting liquid composition by the weighted average of the base liquids'refractive indices and weighting the average based on the volume fraction of each base liquid; and
(b) determining the viscosity of the resulting liquid composition by the weighted average on a logarithmic scale optionally using an Arrhenius equation, wherein the base liquids and composition ratios are chosen to achieve the desired properties of the compound liquid
(c) introducing the silicone oil composition into a cavity of a decorative object such as an item of jewelry, wristwatch, clock, or any other fashion item.

27. A decorative object enclosed within a chamber filled at least in part with a silicone oil constituent comprising one or more branched or unbranched polysiloxane polymers having a Si—O—Si backbone with a viscosity above 1 cSt and refractive index above 1.33.

28. The decorative object of any one of claims 19 to 24, wherein the object is an accessory such as an item of jewelry, wristwatch, clock, or any other fashion item where the fluidic capsule (100) is integrated.

29. A method of mixing a silicone oil composition comprising at least two, preferably three, silicon oil constituents selected in relative quantities so as to match a refractive index of a transparent material, and at the same time to adjust the kinematic viscosity of the composition within a certain range, wherein the quantities are preferably weighted quantities, comprising following steps:
a) determining target properties (viscosity and refractive index);
b) blending a composition out of two silicon oil constituents of dedicated proportion according to an approximation;
c) measuring the physical properties (viscosity and refractive index) of the blended composition of Step 2;
d) determining the deviation between the target properties as determined in Step I and the physical properties as measured in Step 3—if no deviation, end of process—if there is a deviation, continue with the below step;
e) identifying a third silicon oil constituent and an estimated proportion to the two silicon oil constituents used in Step b), or determine a correction of the proportion of the two silicon oil constituents used in Step b); and
blending composition according to the proportions defined in Step e), go to Step c).

30. A system (700) including a light source (722) installed on a mobile element (732) held loosely in a structure (742), immersed in a composition as defined in of any of the claims 1 to 18.

31. A system (800) including a chain (810) of rigid links (812) attached via articulating joints, guided with pulleys (822), grooves or guides (824) to follow a predefined path, actuated by a mechanism (820), immersed in a composition as defined in of any of the claims 1 to 18.

32. A dampening system using the composition of one of claims 1 to 18, adapted to dampen the acceleration of a shock-sensitive device such as a watch movement or any shock-sensitive device, wherein a fluid composition (1003) is used to dampen the shock, the composition of which is tuned in order to control the damping level of the system and wherein reflection of light at the interfaces between the silicone oil constituent mixture and transparent objects in contact with the transparent objects are matched to lower or suppress the optical refraction, thereby enabling a motion if the device is submitted to acceleration dampened by the fluid composition (1003) with tuned viscosity.

33. The system of the above claim, wherein the transparent objects include one of the group of transparent objects consisting of chamber sidewalls and immersed objects.

34. The system of claim 32 or 33, wherein the shock-sensitive device (1001) is sealed in a hermetic capsule surrounded by the fluid composition (1003) having further a selected viscosity and refractive index.

35. The system of one of claims 32 to 34, wherein at least one wall of a case (1002) is transparent and the liquid composition (1003) is optically matched with those of the transparent walls.

36. The system of one of claims 32 to 35, wherein the shock-sensitive device (1001) is suspended by one or several soft (i.e., having a low spring coefficient K) springs (1004) which are softer than required if no liquid suspension composition was used, through which springs the device is suspended to a side and/or a bottom of the case (1002).

37. The system of one of claims 32 to 36, wherein a flexible element such as a corrugated membrane (1005) is used to compensate for the thermal expansion of the liquid.

38. The system of one of claims 32 to 37, wherein the shock-sensitive device is a watch movement, wherein the system includes a clutch-like mechanism (1006) adapted to allow the setting of time or other user functions, the clutch-like mechanism keeping the watch movement suspended only by the springs when the clutch is open.

39. The system of one of claims 32 to 38, including first and second fluid composition filled, flexible membranes (1004, 1005) connected by a channel, wherein the shock-sensitive device is suspended by the first membrane (1004) filled with the fluid composition (1003), such that the fluid is able to flow through the channel and into a volume enclosed within the second flexible membrane (1005) disposed elsewhere in the device.

40. The system of one of claims 38 and 39, wherein the viscosity of the fluid composition (1003) is selected so that upon a shock, the fluid composition is forced into the channel by the motion of the shock-sensitive device (1001) moves under the second flexible membrane (1005), hereby damping the motion of the device (1001) by shear forces in the liquid.

41. The system of one of claims 39 and 40, wherein an amount of damping of the system is tuned by the dimension of the channel.

42. The system of one of claims 39 to 41, wherein the system includes a watch movement and a clutch-like mechanism (1006) adapted to set the time or other user functions, keeping the watch movement suspended only by the first membrane (1004) when the clutch is open.

43. The system of one of claims 39 to 42, wherein anticipated thermal expansion of the fluid composition is absorbed by the flexibility of the two membranes.

44. The system of one of claims 36 to 43, wherein the spring is a flexible bellows, wherein the flexible membrane is optionally embedded within this flexible bellows, preferably at its center.

45. The system of any one of claims 30 to 44, wherein a decorative element is suspended in a chamber disposed therein, loosely captured between two adjacent structural elements, the chamber being filled with a liquid.

46. The system of any one of claims 30 to 45, wherein the decorative element is an electrical light source connected to circuits disposed to contact the structural elements thereby making an electrical connection that activates the electrical light source when the decorative element moves to a contact position, wherein, optionally, the electrical light source and/or the electricity conducting elements are made invisible through a proper selection of refractive indices.

47. The system of one of claims 30 to 46, wherein at least one decorative element is suspended therein, having a neutral buoyancy within the composition and therefore tends to float therein.

48. The system of one of claims 30 to 47, wherein at least one decorative element is suspended in a capsule filled with the composition, and wherein further, an agitator impellor made of a materials whose refractive index is matched to the composition is configured to agitate the composition, thereby causing movement of the at least one decorative element in the capsule.

49. The system of one of claims 30 to 48, wherein the decorative element has a first density and is suspended in a capsule comprising the composition at the interface between two liquids, at least one of the two liquids being a formulation of the composition, one of which has a density significantly greater than the first density, and the other of which has a density significantly less than the first density.

50. The system of one of claims 30 to 49, wherein the viscosity of the oil constituents is tuned to adjust displacement speed of the enclosed objects.

51. A decorative capsule having at least an internal or external light source and one transparent barrier containing a silicone oil composition comprising at least two, preferably three, silicon oil constituents selected in relative quantities so as to match a refractive index of a transparent material, and at the same time to adjust the kinematic viscosity of the composition within a certain range, wherein the quantities are preferably weighted quantities, wherein the refractive index of the composition is superior to the refractive index of the at least one transparent barrier so that the light produced by the light source remains confined within the decorative capsule.

52. The decorative capsule of claim 51 including decorative elements immerged in the composition, wherein the decorative elements scatter some of the light produced by the light source within the capsule towards an observer on the outside of the capsule, therefore making these objects more visible or rendering them shiny.

53. A decorative capsule having at least an internal or external light source and one transparent barrier containing a silicone oil composition comprising at least two, preferably three, silicon oil constituents selected in relative quantities so as to match a refractive index of a transparent material, and at the same time to adjust the kinematic viscosity of the composition within a certain range, wherein the quantities are preferably weighted quantities, wherein one of the one or more transparent barriers is structured to contain positive or negative relief features and wherein the refraction index of the composition is matched to the refraction index of the transparent barrier, wherein the positive or negative relief features scatter some of the light produced by the light source within the capsule towards an observer on the outside of the capsule, therefore making the positive or negative relief features more visible or rendering them shiny.

54. The decorative capsule according to claim 53 including decorative elements immerged in the composition, wherein the decorative elements scatter some of the light produced by the light source within the capsule towards an observer on the outside of the capsule, therefore making these objects more visible or rendering them shiny.
